(19) United States
(12) Patent Application Publication
(10) Pub. No.: US 2001/0023174 A1
(43) Pub. Date: Sep. 20, 2001

(54) Network of communication modules and elementary, portable and fixed communication modules of this network

(76) Inventor: Philippe Charbonnier, Le Mesnil Le Roi (FR)

Correspondence Address: Eugene C. Rzucidlo, Greenberg Traurig LLP, 21st Floor, 885 Third Avenue, New York, NY, 10022, US

(21) Appl. No.: 09/758,784

(22) Filed: Jan. 11, 2001

(30) Foreign Application Priority Data
Jan. 13, 2000 (FR) 00 00381

(51) Int. Cl. H04B 5/00

(52) U.S. Cl. 455/41; 455/422

(57) ABSTRACT

The network (30) makes it possible to access exterior transmission networks (20). It is a hierarchical modular network, each pair of modules of different elaborateness (22, 23; 22, 25; 27, 23; 24, 25; 24, 22) being subject to a double upward and downward hierarchy. Each communication module comprises, in order to associate it with at least one other module of the network, a short-range internal interface configured so as to share the short-range medium with the interface of the said other module.

Cellular telephone users are becoming more and more demanding and want more and more things and manufacturers are willingly going along with such demands.

However, there are limits, namely the power available, the size and the man/machine connection MMC interface.

At the present day it is not possible to equip cellular telephones with the sophisticated MMC interface which would be suitable for exploiting all office-automation and multimedia application packages.

Hence, the applicant is proposing the inventive concept described and claimed hereinbelow, relating to communication modules of diverse elaborateness and the network of such modules.

A module is firstly defined with regard to

its ergonomic means,

its means of communication with exterior transmission networks,

its power means,

its application means,

its size,

all these means and other characteristics of the module being naturally interrelated.

By way of ergonomic means, mention may be made for example of

sight-typing means (screen, console, pen/touch-sensitive screen),

acoustic means (microphone, loudspeaker, voice recognition device, voice synthesizer), to say nothing of

conventional manual means.

By way of exterior networks, mention may be made, for example, of telephone networks, computer networks, radio broadcasting networks.

By way of power means, mention may be made of the mains, rechargeable batteries, including solar batteries, chemical cells and accelerometric cells.

By way of application means, consideration will be given to the internal means within the module, external but peripheral means, and external and remote means.

By way of internal application means, mention may be made of memory means for capturing and reading messages.

By way of peripheral application means, mention may be made of printers, multimedia equipment and navigation equipment.

By way of remote application means, mention may be made of personal and home-automation equipment, such as domestic electrical equipment and cars.

The elementary module

This is provided only with acoustic ergonomic means, its power capabilities are very small and it is of particularly small size, it being a miniature module or a pocket module. The remainder of its means stem therefrom.

Ergonomic means

It possesses only an earpiece (loudspeaker), a microphone and a voice control device.

Size

Its size is such that it can be carried upon the person permanently, even in the form of a bracelet or necklace, or it can be hooked up at home or into one's car, for example to the sun visor.

Application means

Its only internal application means, if they exist, are telephony means to which may be appended messaging means, means for receiving radio broadcast signals, etc.

Communication with exterior transmission networks

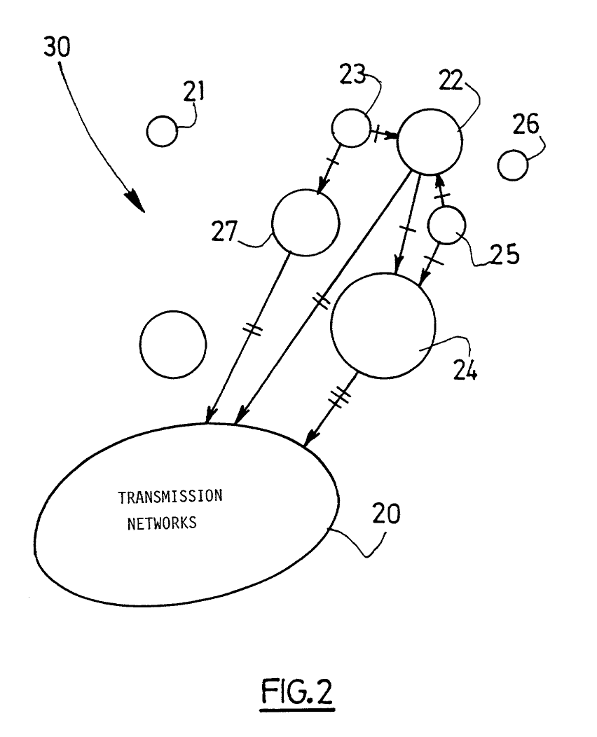

Indirectly, by way of a short-range internal interface (arrowed link crossed with a bar in FIG. 2) on the one hand, and of another module of greater capabilities, on the other hand, it can access exterior networks and all the application means of this other module. Under these circumstances, the elementary module is then the master for the purposes of ordinary telephony and can transfer its authority to the other module for the purposes of more elaborate telephony applications or sophisticated communications, thus becoming the secondary module in respect of the said other module.

Directly, and as far as the exterior networks are concerned, it can receive radio broadcast signals and, as a variant, also access a cellular radio telephony network.

The miniature elementary modules considered here can thus take the form of, for example,

a low-power cellular telephone without a keypad,

a wireless micro-headphones assembly,

a handset, again without a keypad, a wireless telephony DECT base, etc.

Generally, a miniature elementary module is therefore

a master transmitter module for voice control of another module of greater capabilities,

a secondary transmitter/receiver module, peripheral to the said other module for accessing its application means and the exterior networks, subsidiarily

a radio broadcast receiver module,

a low-power cellular radio telephony transmitter/receiver module,

a module with unique messaging application means.

The portable module

This is a much more elaborate module which, though able to sometimes be a pocket module, is more generally a briefcase or attache-case module, or even a car module or a street terminal module. Its power resources are considerable.

Ergonomic means

In addition to those of the elementary module, it also possesses sight-typing and manual means.

Application means

It can possess almost all the possible application means, directly or indirectly, beginning with those of a printer, including those of a personal computer, of a radio telephony set, of locating equipment, of navigation equipment, of a videophone. It accesses the home-automation remote application packages only by way of a yet more elaborate fixed module. These application means are easily upgradable.

Communication with exterior networks

It is provided with means affording it radio access to any exterior network, comprising a long distance interface with this network (arrowed link crossed with two bars in FIG. 2).

Generally, a portable elaborate module is a transmitter/receiver module which is both master and secondary with regard to another elementary or yet more elaborate module to which it can be linked by a short-range internal interface.

The fixed module

This is very similar to the portable module. Being fixed, it has an unlimited supply of power and has direct radio and/or wireless access via a fixed interface (arrowed link crossed with three bars in FIG. 2), to any exterior network, and in particular the ISDN integrated services network, cable networks, local area networks (LANs), high speed radio links, etc.

Naturally without locating and navigating equipment, it possesses, on the other hand, application packages for controlling personal and home-automation machines and equipment.

Generally, a fixed module is a transmitter/receiver module which is both master and secondary with regard to another elementary or portable module to which it can be linked by a short-range internal interface.

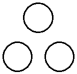

Yet more generally, the portable and fixed elementary modules constitute a hierarchical modular network, each pair of modules of different elaborateness being subject to a double upward and downward hierarchy.

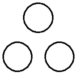

One of the main advantages of this double hierarchical network structure needs to be underlined immediately.

By virtue of the hierarchical structure presented hereinabove, the elementary module, in this instance a telephone module, is easy to carry and possesses a rudimentary, or even minimal, MMC interface, while the briefcase module, linked to the elementary module, contains the rest: the sophisticated MMC interface, the accesses to the networks, the power means. However, the MMC interface of the elementary module has the characteristic of being single-talker and therefore the advantage of offering high performance to the person carrying it.

In its minimal version, the miniature elementary module, which serves directly merely for telephony, operates only in proximity to a portable module, closed or open if in a briefcase, as is easily possible, without affecting the feeling of freedom of movement. For office-automation and multimedia applications, it suffices to open the portable module.

In its stand-alone version, the miniature elementary module, when it is in proximity to a portable module, may nevertheless access the telephone networks automatically by way of the portable module so as to save its power.

Advantageously, there may be provided, in the communication modules, telephony application means configured so as, during communication and via a short-range link, to cooperate with telephony application means of another communication module of different elaborateness and to determine that a substitution of access is possible and/or desirable.

In this instance, it is preferable that, having acquired the parameters of a communication of another module of different elaborateness with an exterior network, the telephony application means be configured so as to transmit in superposition with the said other module before substituting itself therefor.

Again preferably, the telephony application means are configured so as, in order to proceed with the substitution, to transmit in superposition under TD/CDMA.

The invention will be better understood with the aid of the following description and of the appended drawing, in which

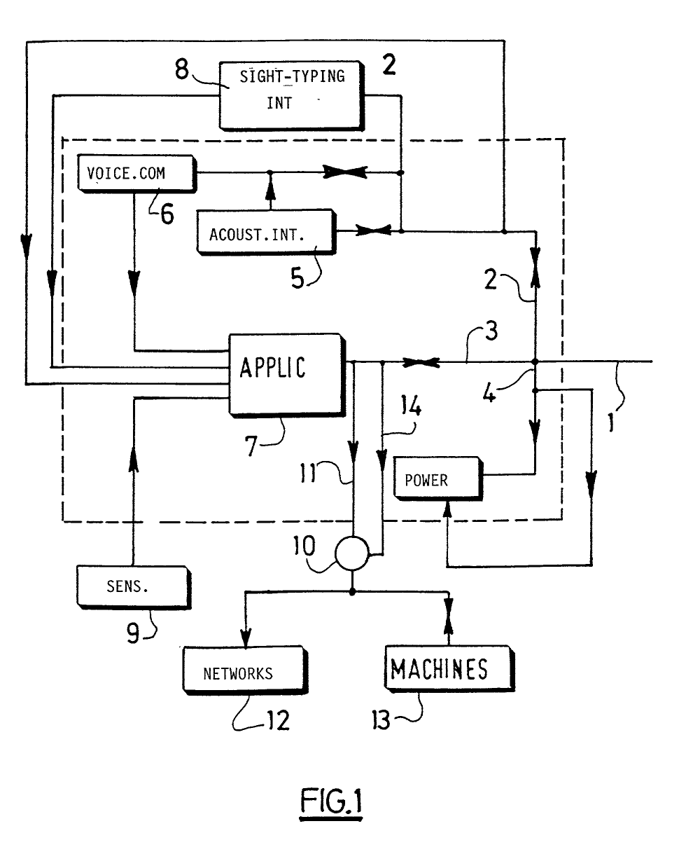

FIG. 1 represents the three strata of the short-range internal interface, these strata being shown diagrammatically by blocks and

FIG. 2 illustrates a network of portable and fixed elementary modules of the invention.

The short-range internal interface

This comprises an ergonomics stratum, an activation stratum and a power stratum.

Ergonomics stratum

This involves man-related information, that is to say the events of the man/machine interface (MMC), such as the audio signal from the microphone or intended for the loudspeaker, the screen signals or console stimulation signals when there is a screen or console.

The short-range internal interface can support prior compacting of the information by vocoding of voice commands or through a voice recognition device. In the case of vocoding, the short-range link transmits the uninterpreted voice signal coded more or less compactly. In the case of voice recognition, the short-range link transmits the gist of the speech, which is much more compact still.

Thus, and within the context for example of the control of a fixed module by an elementary module,

for a telephony application, the voice recognition will be implemented in the elementary module well matched to the voice of its operator,

for a home-automation application unknown to the elementary module, the voice recognition will be implemented in the fixed module, which is more powerful and multi-talker, the voice signals of the elementary module being vocoded (International Telecommunications Union standards G711, G723 etc.).

For a home-automation application, from a portable module of a third party unaccustomed to the voice of the operator of the relevant elementary module, the same process is employed, with voice recognition in the fixed module.

Actuation stratum

This involves information relating to the peripheral and remote application means, for example for the printing of files, for the control of machines.

Power stratum

This involves the power for operating or recharging the module via a more powerful and elaborate module.

In FIG. 1, the functionalities of the elementary module are represented inside the dashed frame.

The short-range link, or medium, 1 is divided into an ergonomics link 2, an actuation link 3 and a power link 4.

Ergonomics link

The acoustic interface 5, which is lightweight in an elementary module and convenient in a portable or fixed module, transmits the information from the microphone and receives the information for the loudspeaker. It feeds the voice control 6 which can also be fed by another module of the network.

The voice control 6 instructs applications 7 of its module or applications of another module.

In a more elaborate module than an elementary module, a sight-typing interface 8 operates in parallel on the acoustic interface and the voice control.

Actuation link

The applications transmit their commands via this link and receive states in return, via this link.

With an elementary module, it is possible only to prepare messages, receive radio broadcast signals and, in certain instances as mentioned hereinabove, also to telephone. As seen earlier, with a more elaborate module it is possible to envisage, not only telephony, but also multimedia, office-automation, navigation and location applications and, with a fixed module, home-automation applications.

The applications may receive inputs from sensors 9, navigation and location sensors for a mobile module, and home-automation sensors for a fixed module.

With more elaborate modules than an elementary module, through a circulator 10 there is access (11) to the exterior networks, via a long-distance interface 12 (conventional contemporary radio or IMT 2000 radio) with a mobile module, fixed interface with a fixed module, as well as to the machines 13, with a fixed module. Conversely, accessibility to the actuation networks of the machines may be obtained (14) by applications of other modules through the circulator 10.

Power link

The power link is unidirectional in an elementary module, this being a recharging link. It is bidirectional in the more elaborate modules.

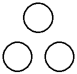

The short-range internal interface uses a medium allowing the transport, by multiplexing, of the information of the ergonomics and actuation strata. It may be a packet mode LAN radio link, a DECT link, an IMT 2000 link, a Bluetooth link, etc.

As far as the power stratum is concerned, this uses connectors with metal contacts or very-short-distance induction.

Various technologies can be used as bottom layers, standardized or not, of the short-range internal interface. They all boil down to sharing a medium between several apparatuses in packet mode, in circuit mode or both.

In this instance, use is made of the packet mode for the actuation stratum and the signalling of the ergonomics stratum and the circuit mode for the audio signals of the ergonomics stratum. However, in the manner of telephony over the Internet, it is also possible to pass the audio signals in packet mode if the method of access to the medium ensures, in a deterministic or statistical manner, a small and not overly fluctuating delay.

Layers 1, 2

In packet mode, the data units are datagrams containing an identification of the sender and recipient entities and a useful information item which is a layer 3 datum. These datagrams are transmitted, and retransmitted should there be a collision, according to a procedure for accessing the medium (RLAN procedure for example).

In circuit mode, a point-to-point pipe is open between the two entities. Under regular multiplexing, a transparent data path (B channel) and a control path (D channel) are sent therethrough; a repetition procedure (on D channel, sometimes also on B channel) can recover the errors (DECT procedure for example).

Layer 3

The layer 3 data units convey layer 3 commands or application data entities. The coding enables the receiving entity to know which one. In packet mode, layer 3 entrusts its data units indiscriminately to layer 2. In circuit mode, it entrusts them to the B or D channel; generally, layer 3 commands, and applications with a small amount of data (messaging, control of machines) are entrusted to the D channel and applications with a large amount of data (audio, office automation) are sent over the B channel.

The layer 3 handlers furthermore contain procedures for managing mobility and access entitlements: the various modules track the degradation or the strengthening of the short-range link, the appearance or disappearance of other modules and recognize friendly modules whose capabilities they can use or whose requests they can receive.

Application layer

The applications exchange data units from one module to another, by multiplexing on the short-range medium, each unit containing within its coding a distinction of the different applications. The data units are application commands or data. The primitive to layer 3 explicitly or implicitly comprises an indication of quality of service required to be sent over the D channel or over the B channel, or in packet mode with controlled delay. A primitive is the set of data transmitted to a specified layer by a layer of immediately higher or lower rank, depending on whether dealing with transmission or reception.

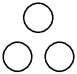

The network of portable and fixed elementary modules of FIG. 2 can access a set of exterior networks 20, enabling the less elaborate modules to use the capabilities of more elaborate modules when they are within their range.

Only with a miniature elementary module 21 is it possible merely to prepare messages or to listen to the radio broadcast, and possibly to telephone.

In proximity to a portable module 22 it is possible, from a miniature elementary module 23, to undertake telephony or messaging, using the application of the miniature module 22, the actuation stratum to the portable module 22 and the external network access of the portable module 22 (solution 1) or else, from the miniature module 23, to use the ergonomics stratum to the portable module 22, the telephony application of the portable module 22 and the network access of the portable module 22 (solution 2). One or other solution is chosen depending on the particular features of the appropriate applications (the telephone directory of one or the other for example). Likewise, the ergonomics of the most suitable module are chosen: being in proximity to the portable module, one can decide to use the acoustic interface (convenient) of the miniature module 23, or ultimately choose not to use it and instead to prefer that (of better quality) of the portable module 22, in which case the miniature module 23 is not used at all.

The same process is employed from an elementary module 25, in proximity to a fixed module 24.

Several elementary modules 23, 25, 26 can be associated with one and the same portable module 22 and, conversely, one elementary module 23 can be associated with several portable modules 22, 27, with the proviso that there is one and the same internal interface and that there is mutual recognition via a prior registration procedure.

The same hierarchy exists between the elementary and fixed modules, on the one hand, and the portable and fixed modules, on the other hand. In all these cases, the short-range medium is shared by the internal interfaces.

This facility of variable association can be controlled manually or automatically. It will also be possible to envisage semi-automatic control, to detect the choices available and present them to the operator with an indication of the best solutions to be adopted as a function of predetermined criteria.

### EXAMPLE

An operator has available an elementary module with a radio telephony block and places a telephone call. The elementary module notes that it is within short range of a portable module and of a fixed module. Given that i) the elementary module is furnished with its own radio telephony access but that it must spare its battery, ii) the fixed module reports for example that its wire line is currently busy and iii) the portable module reports that its radiotelephone access is available, the telephony application decides (automatic association) or suggests (semi-automatic association) that the call be made by the portable module.

It will be noted that the sharing of roles can evolve during action by

substitution of access,

substitution of MMC.

Substitution of access

In GSM communication on one's portable module, one approaches one's home. The short-range link is established between one's portable module and one's domestic fixed module. The telephony application distributed between the two and cooperating via the short-range link 1 determines that a substitution of access is possible (the STN line is available) and desirable (better tariff and quality).

By way of example, via a voice MMC, the telephony application automatically warns the two talking parties: “wait a few seconds”. It requests transfer by GSM signalling indicating the wire number. The communication in progress is put on hold and the network calls the STN telephone number. The telephony application immediately causes the wire line to go off-hook as soon as it rings (advantageously, it verifies that it is indeed the correct caller by means of the service for identifying the caller via the network). By GSM signalling, it causes the GSM access to hang up. It connects the MMC of the portable module (micro earpiece, commands) with the wire network access of the fixed module. The communication is continued on the portable module, but via the short-range link and the STN access.

Conversely, one has, at home, instigated an STN communication from one's portable module via the short-range link. One moves away from the house. Noting the drop in the signal of the short-range link, the telephony application assesses that a substitution of access is desirable and possible (the GSM access is available). It warns and requests transfer to the STN (R+No. of the GSM access). It goes off-hook on the GSM access as soon as the latter rings, orders the STN access to hang up and connects the acoustic and control interface of the portable module with the GSM access.

Likewise, if one if engaged in IMT 2000 conversation directly from an elementary module which one is carrying upon one's person, and if one is approaching one's car, which is equipped with a portable module which has a larger reserve of power, as soon as the short-distance link is established between them, the telephony application assesses that a substitution of access is desirable (so as to save the power of the elementary module) and possible (the network access of the portable module is available and operates on the same (split) SIM subscription).

Via the short distance link, the elementary module passes the parameters of the communication in progress to the portable module: frequency, TDMA frame number, CDMA code, approximate time reference of the start of the framing and of the code. The portable module locks onto the network and sharpens its synchronization. It transmits in TD/CDMA mode in superposition with the elementary module. The receiver of the network receives this superposition correctly, owing to the fact that it uses a rake receiver and that the latter sees a superposition as a straightforward additional echo. The MMC of the elementary module is connected with the network access of the portable module via the short-range link. When the portable module signals that it has indeed taken over, the network access of the elementary module is cut off.

The conversation is continued on the MMC of the elementary module but it travels via the short-distance link and the network access of the portable module.

Thereafter, one may decide to switch MMC to that of the portable module (hands free in the rear-view mirror for example). The elementary module and the short-distance link are then no longer involved.

Registration procedure

The user approaches a virgin module for registration of an already registered module and carries out a manipulation between the two. The items of apparatus exchange signallings comprising a group identity. The items of apparatus then recognize one another as elements of the same group. Cryptological elements may be appended thereto, but the starting authentication is the fact that the user acts on the already registered module.

The starting module (typically a fixed module) defines a group identity, which is rendered unique, by being based on its manufacturer identity and the serial number, for example. On registering other modules on these, they become bearers of this group identity, and can indicate same to one another and interoperate directly.

The group identity has to be unique because a portable module can be registered on several fixed modules (house, office) and they must not have the same group identity by chance.

1. Network (30) of communication modules making it possible to access exterior transmission networks (20), characterized in that it is a hierarchical modular network, each pair of modules of different elaborateness (22, 23; 22, 25; 27, 23; 24, 25; 24, 22) being subject to a double upward and downward hierarchy.

2. Communication module for a network (30) according to claim 1, characterized in that it comprises means for associating it with at least one other module of the network, comprising a short-range internal interface configured so as to share the short-range medium with the interface of the said other module.

3. Communication module according to claim 2, in which there are provided means of optimization of association, for controlling the means of association, comprising manual means and automatic means.

4. Communication module according to claim 2, in which the short-range internal interface comprises an ergonomics stratum, an actuation stratum and a power stratum, the ergonomics stratum being configured so as to perform voice recognition and vocoding of speech.

5. Module according to claim 4, in which the information of the ergonomics and actuation strata of the short-range internal interface are multiplexed.

6. Module according to claim 4, in which the ergonomics stratum of the short-range internal interface is associated with the actuation stratum of the short-range internal interface of an associated module.

7. Elementary communication module (23) intended to access at least one exterior transmission network (20), comprising ergonomic means, application means, power means and means of communication with the transmission network (20), characterized in that the means of communication comprise a short-range internal interface for communicating indirectly with the transmission network (20) by way of at least one more elaborate communication module (22, 24; 27).

8. Elementary module according to claim 7, in which the ergonomic means are exclusively acoustic means.

9. Elementary module according to claim 7, in which the application means consist exclusively of messaging means.

10. Elementary module according to claim 7, which is a master transmitter module for voice control of the more elaborate module.

11. Elementary module according to claim 7, which is a peripheral secondary transmitter/receiver module of the more elaborate module.

12. Portable communication module (22) intended to allow an elementary module (23), according to claim 7, to access at least one exterior transmission network (20), comprising sight-typing ergonomic means and a long-distance communication interface for communication with the exterior transmission network.

13. Portable module (22) according to claim 12, which is a master and secondary transmitter/receiver module with regard to another elementary (23) or more elaborate (24) module to which it can be linked by the short-range internal communication interface.

14. Fixed communication module (24) comprising ergonomic, application and communication means similar to those of the portable module (22) according to claim 12, the application means comprising control means for personal and home-automation equipment and machines and there is provided a fixed communication interface.

15. Fixed module (24) according to claim 14, which is a master and secondary transmitter/receiver module with regard to another less elaborate module (22) to which it can be linked by the short-range internal communication interface.

16. Module according to claim 7, in which there are provided telephony application means configured so as, during communication and via a short-range link (1), to cooperate with telephony application means of another communication module of different elaborateness and to determine that a substitution of access is possible and/or desirable.

17. Module according to claim 16, in which, having acquired the parameters of a communication of another module of different elaborateness with an exterior network, the telephony application means are configured so as to transmit in superposition with the said other module before substituting itself therefor.

18. Module according to claim 17, in which the telephony application means are configured so as, in order to proceed with the substitution, to transmit in superposition under TD/CDMA.
